(19) United States
(12) Patent Application Publication
(10) Pub. No.: US 2009/0063480 A1
(43) Pub. Date: Mar. 5, 2009

(54) SYSTEM AND METHOD FOR SEARCHING A TERM IN AN ACTIVE COMPONENT OF A USER INTERFACE

(76) Inventor: Goutham Tholpadi, Bangalore (IN)

Correspondence Address: SAP AG, 3410 HILLVIEW AVENUE, PALO ALTO, CA, 94304, US

(21) Appl. No.: 11/848,242

(22) Filed: Aug. 31, 2007

(51) Int. Cl. G06F 17/30

(52) U.S. Cl. 707/6; 707/E17.008

(57) ABSTRACT

Embodiments of the invention are generally directed to a system and method for searching a term in the active component of a user interface. A repository term generator generates a repository term associated with an active component of a user interface. A search engine searches for a term corresponding to the repository term. An output device provides the result corresponding to the term. In an embodiment, the result may contain one or more repository terms, the user interface provides for a selection and display of this selected repository term. In another embodiment, the selected repository term is navigated and expanded to display the term in the user interface.

### FIELD OF THE INVENTION

Embodiments of the invention generally relate to the field of User Interface (UI) of a software application and more particularly, to a system and method for searching a term in the active component of a UI.

### BACKGROUND OF THE INVENTION

A user interface (UI) provides access and control to an automated system. In a computer system, a graphical user interfaces (GUI) accepts input via devices such as a computer keyboard and a pointing device that is used to provide articulated graphical output on to the computer monitor.

At times, when the user is using a complex GUI, most actions are not transparent to the user. A rich GUI is loaded with information and finding what he is looking for can be cumbersome. Further all actions that can be performed are not immediately accessible to the user. The possible actions are hidden behind several layers of navigation and it takes a lot of searching before the user can find a desired option. Thus, the user has to go through several layers of navigation before the required functionality can be found. Navigation within the UI is a serious problem, especially for the users those who are new or are not familiar with the application. Traversing through such a multilayer navigation path to reach the desired command is extremely difficult especially for users who are visually or physically challenged, as they would have to navigate through several irrelevant layers before arriving at the required action.

Another approach to solve the problem of a multilevel navigation is by providing an application-specific help. The application help is a text search performed on documents containing the explanation and the information. These set of documents are maintained by the application. When the user searches on a keyword, a search is made on these documents and the documents containing matching text are displayed in a result set. This search is specific to the application and not generic. Further for each successive versions, the help documents have to be rewritten. Also the user has to undergo a lot of learning of the location of these new actions and it is also time consuming.

### SUMMARY OF THE INVENTION

Embodiments of the invention are generally directed to a system and method for searching a term in the active component of a user interface. A repository term generator generates a repository term associated with an active component of a user interface. A search engine searches for a term corresponding to the repository term. An output device provides the result corresponding to the term. In an embodiment, the result may contain one or more repository terms, the user interface provides for a selection and display of this selected repository term. In another embodiment, the selected repository term is navigated and expanded to display the term in the user interface.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a flow diagram illustrating a method for searching a term in a user interface, according to an embodiment of the invention.

FIG. 2 is a system block diagram illustrating an implementation, according to an embodiment of the invention.

FIG. 3 is a screen display of an example graphical user interface illustrating searching for a term, according to an embodiment of the invention.

FIG. 4 is a screen display of a graphical user interface illustrating a search for a term in the active component of a user interface, according to an embodiment of the invention.

FIG. 5 is a screen display of a graphical user interface illustrating a keyword search in the application, according to an embodiment of the invention.

FIG. 6 is a screen display of a graphical user interface illustrating an expanded submenu until the required submenu is found, according to an embodiment of the invention.

### DETAILED DESCRIPTION

Embodiments of the invention are generally directed to a system and method for searching a term in the active component of a user interface. A repository term generator generates a repository term associated with an active component of a user interface. A search engine searches for a term corresponding to the repository term. An output device provides the result corresponding to the term. In an embodiment, the result may contain one or more repository terms, the user interface provides for a selection and display of this selected repository term. In another embodiment, the selected repository term is navigated and expanded to display the term in the user interface.

Embodiments of the invention are generally directed to a system and method for searching a term in the active components of a UI. A term is an identifier of the command embedded in a menu of a UI. An active component is anything that one can select with a mouse click that performs some function when selected. Examples of an active component of a user interface includes labels, icons, commands, hyperlinks, clickable images, buttons, folders, window menu, pull-down menu, menu bars, tool bars, scroll bars, status bars, windows, pop-up windows, desktop pane and internal panes. Each active component can have some term associated with it. In an embodiment, the terms associated with the active component of an application program are indexed. The indexing program identifies an array element or n-ary tree structure any other data structure for storing and quick accessing of these indexed terms and stored them in a repository. Each such stored term in the repository is called a repository term. A search for a term corresponding to the repository term of the application yields a result corresponding to such a term. Enabling keyword searching on the text of menus, the buttons and the other active components in a user interface provides the user with a similar searching functionality for any application window.

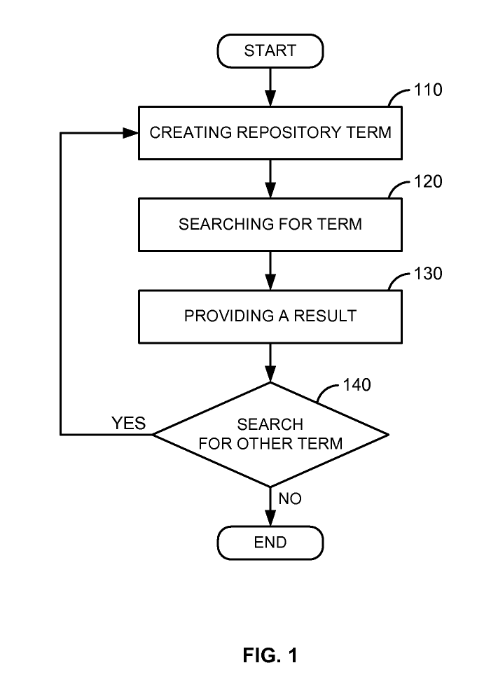

FIG. 1 is a flow diagram illustrating a method for searching a term in a user interface, according to an embodiment of the invention. An active component can represent a command within a hierarchy of commands, in one embodiment of the invention. The sample application could be either be SAP GUI®, Microsoft Word®, Microsoft Excel®, Notepad etc. In an embodiment of the invention, the text in the term of an active component of the user interface is indexed to create a repository term at 110. The created repository term is associated with an active component of the user interface. A search at 120 for the term corresponding to the repository term yields a result at 130. The result of 130 is displayed in a UI. According to an embodiment of the invention, the search result is a hyperlink of commands. The result of the search is displayed in a window or a pane of a window. Further any other terms can be searched at 140.

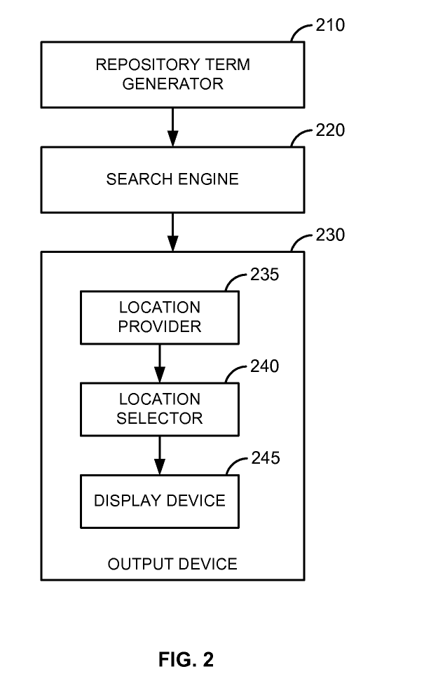

FIG. 2 is a system block diagram illustrating an implementation, according to an embodiment of the invention. A repository term generator at 210 creates a repository term associated with an active component of the user interface. The search engine at 220 searches for the term from this generated repository terms. The search engine at 220 can be an independent program or an attachable program. The output device at 230 displays the result of the search. In an embodiment, the result of the search is expandable to reach the term of the active component. The output device comprises of a location provider at 235, a location selector at 240 and a display device at 245. The location provider at 235 provides the location of the term. The location selector at 240 provides selecting the location of the term. A display device at 245 to display the location of the term.

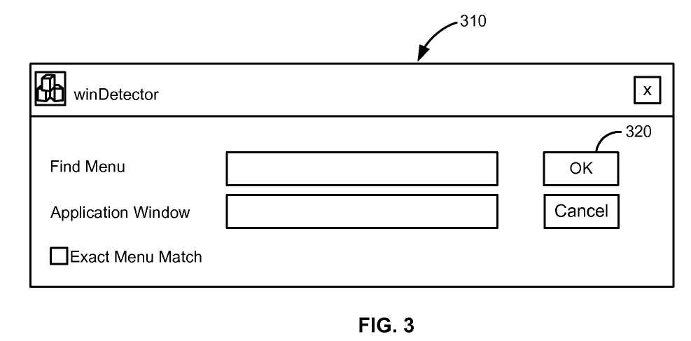

FIG. 3 is a screen display of an example graphical user interface illustrating searching for a term, according to an embodiment of the invention. FIG. 3 illustrates the use of the invention for searching a term at 310 of the active component in a UI. The desired term is to be provided for searching along with the restrictions. On clicking the “Ok” button at 320 the desired term is searched for.

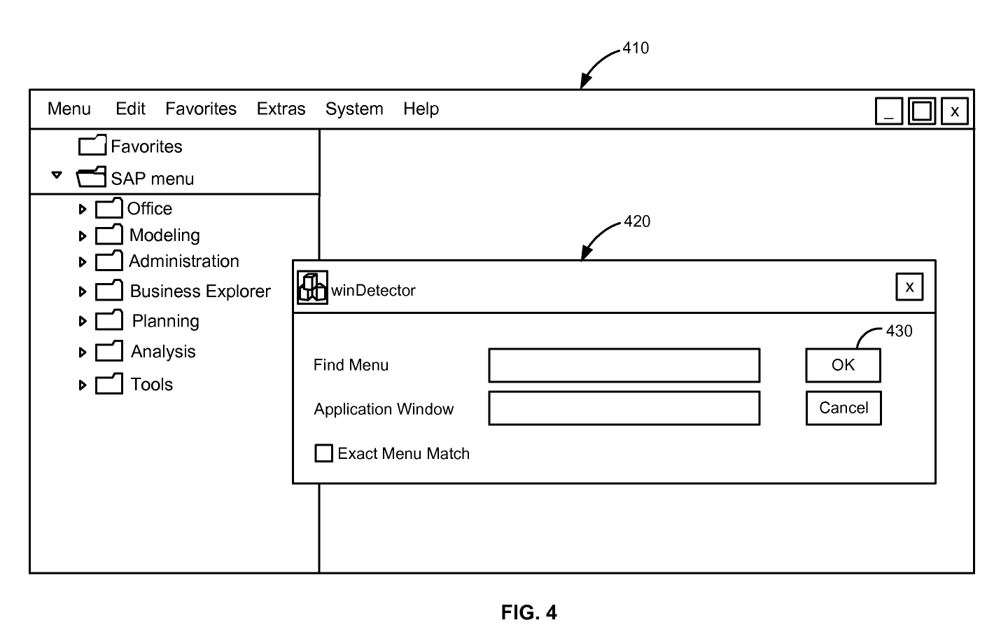

FIG. 4 is a screen display of an example graphical user interface illustrating a search for a term in the active component of a user interface, according to an embodiment of the invention. The FIG. 4 demonstrates the use of the invention on an application program at 410. In an embodiment the application program is a SAPGUI™ as illustrated. Other examples of application programs are Microsoft Word®, Microsoft Excel® or any other application program. The desired term can be searched at 420 on clicking “OK” button at 430.

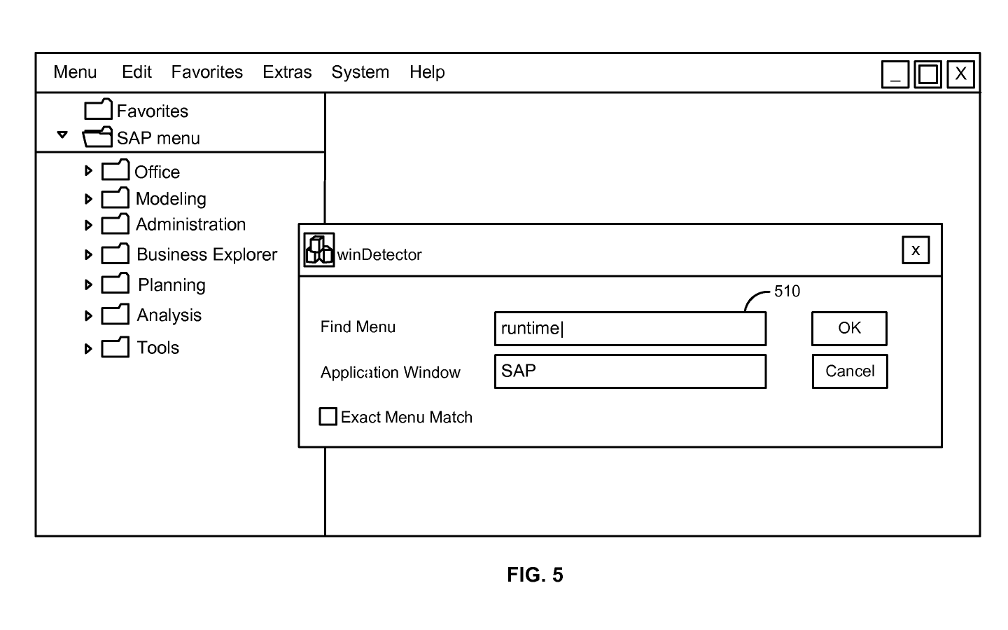

FIG. 5 is a screen display of a graphical user interface illustrating a keyword search in the application, according to an embodiment of the invention. The figure illustrates the use of the invention of searching the keyword “runtime”, the keyword is to be entered in the provided search field textbox at 510 of the UI. The name of the application along with restrictions is to be provided at the time of searching for the term.

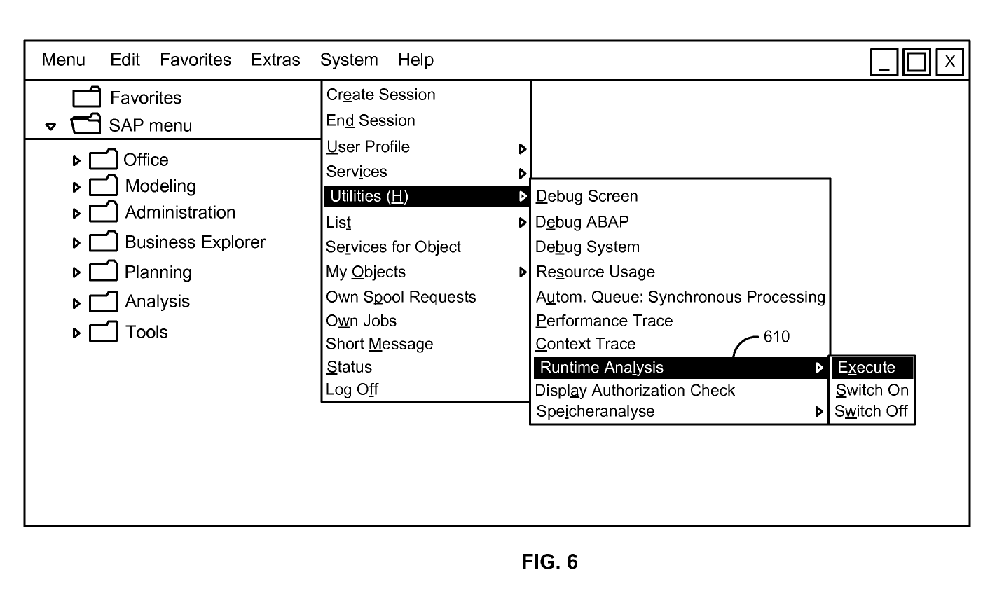

FIG. 6 is a screen display of a graphical user interface illustrating an expanded submenu until the required submenu is found, according to an embodiment of the invention. When a match for this term is found, the location of that menu item is highlighted at 610. Further the menus are recursively expanded until the right submenu which matched the search criterion is shown as illustrated in FIG. 6.

In another embodiment of the invention, if there is more than one active component with matching term then all such matching repository terms can displayed in the result window. Each of these entries is the terms of the navigation route. The term is a text description of the associated active component. These terms or text descriptions are also links to the desired action.

Other embodiments of the invention may be implemented in digital electronic circuitry, or in computer hardware, firmware, software, or in combinations of them.

Elements of the invention may also be provided as a machine-readable medium for storing the machine-executable instructions. The machine-readable medium may include, but is not limited to, Flash memory, optical disks, CD-ROMs, DVD ROMs, RAMs, EPROMs, EEPROMs, magnetic or optical cards, propagation media or other type of machine-readable media suitable for storing electronic instructions.

Throughout the foregoing description, for the purposes of explanation, numerous specific details were set forth in order to provide a thorough understanding of the invention. It will be apparent, however, to one skilled in the art that the invention may be practiced without some of these specific details. The underlying principles of the invention may be employed using a virtually unlimited number of different types of input data and associated actions.

Accordingly, the scope and spirit of the invention should be judged in terms of the claims which follow.

What is claimed is:

1. A method comprising:
creating a repository term associated with an active component of a user interface;
searching for a term corresponding to the repository term; and
providing a result corresponding to the term.

2. The method of claim 1, wherein the repository term comprises a set of repository terms.

3. The method of claim 1, wherein the repository term comprises a menu of commands.

4. The method of claim 1, further comprising an indexing program that identifies a data structure for the repository term.

5. The method of claim 1, wherein the active component of the user interface comprises selecting the active component from a group consisting of labels, icons, commands, hyperlinks, clickable images, buttons, folders, window menu, pull-down menu, menu bars, tool bars, scroll bars, status bars, windows, pop-up windows, desktop pane and internal panes.

6. The method of claim 1, wherein searching for the term comprises a first program searching for the term associated with an active component of the user interface of a second program.

7. The method of claim 1, wherein providing the result corresponding to the term comprises:
providing a location corresponding to the term;
selecting the location of the term; and
displaying the location of the term.

8. A system comprising:
a repository term generator for creating an repository term, the repository term associated with an active component of a user interface;
a search engine for searching for a term corresponding to the repository terms; and
an output device for providing a result corresponding to the term.

9. The system of claim 8, wherein the repository term generator comprises a repository of a set of terms.

10. The system of claim 8, wherein the repository term generator comprises a menu of commands.

11. The system of claim 8, further comprising an indexing program that identifies a data structure for the repository term.

12. The system of claim 8, wherein the search engine searching for the term comprises a first program searching for the term, the term associated with an active component of the user interface of a second program.

13. The system of claim 8, wherein the output device providing the result corresponding to the term comprises:
a location provider for providing a location corresponding to the term;
a location selector for selecting the location of the term; and
a display device for displaying the location of the term.

14. An article of manufacture, comprising:
a machine readable medium having instructions for causing the machine to execute a method comprising:
creating an repository term associated with an active component of a user interface;
searching for a term corresponding to the repository terms; and
providing a result corresponding to the term.

15. The machine-accessible medium of claim 14, wherein the repository term comprises a set of repository terms.

16. The machine-accessible medium of claim 14, wherein the repository term comprises a menu of commands.

17. The machine-accessible medium of claim 14, further comprising an indexing program that identifies a data structure of the repository term.

18. The machine-accessible medium of claim 14, wherein the active components of the user interface comprises selecting from a group of active components consisting of labels, icons, commands, hyperlinks, clickable images, buttons, folders, window menu, pull-down menu, menu bars, tool bars, scroll bars, status bars, windows, pop-up windows, desktop pane and internal panes.

19. The machine-accessible medium of claim 14, wherein searching for the term comprises a first program searching for the term associated with an active component of the user interface of a second program.

20. The machine-accessible medium of claim 14, wherein providing the result corresponding to the term comprises:
providing a location corresponding to the term;
selecting the location of the term; and
displaying the location of the term.
